(19) United States
(12) Patent Application Publication
(10) Pub. No.: US 2014/0174105 A1
(43) Pub. Date: Jun. 26, 2014

(54) SYSTEMS AND METHODS FOR RE-CONDENSATION OF BOIL-OFF GAS

(71) Applicant: General Electric Campany, (US)

(72) Inventors: William Dwight Gerstler, Niskayuna, NY (US); James Edward Simpson, Clifton Park, NY (US); Laura Michele Hudy, Waterford, NY (US); Vaibhav Bahadur, Schenectady, NY (US); Chiranjeev Kalra, Niskayuna, NY (US)

(73) Assignee: General Electric Campany, Schenectady, NY (US)

(21) Appl. No.: 13/726,473

(22) Filed: Dec. 24, 2012

(51) Int. Cl. F17C 7/00

(52) U.S. Cl. CPC F17C 7/00
USPC 62/48.2

(57) ABSTRACT

A system in one embodiment includes a heat exchanger, a detection unit, and a controller. The heat exchanger includes a first passage and a second passage configured for exchange of heat therebetween. The first passage is configured to receive a boil-off gas stream of a first cryogenic fluid. The second passage is configured to receive a liquid stream of a second cryogenic fluid. The detection unit is configured to detect a characteristic of the boil-off gas stream. The controller is configured to, responsive to information acquired from the detection unit corresponding to the characteristic, control the flow of the second cryogenic fluid to provide sufficient exchange of heat from the boil-off gas stream via the heat exchanger to condense at least a portion of the boil-off gas stream. A liquid stream of the first cryogenic fluid is output from the first passage and returned to a first tank.

### BACKGROUND

Cryogenic fluids may be used on-board aircraft, trains, ships, motor vehicles, or in other applications that limit the size or weight of a system utilizing cryogenic fluids. For example, some aircraft engines are configured to use natural gas as fuel. The natural gas may be stored on-board the aircraft as liquid natural gas (LNG), which is a cryogenic fluid. Cryogenic fluids may be stored on-board aircraft within a cryogenic tank that holds a volume of the cryogenic fluid. After a cryogenic tank is filled with LNG, the tank may be exposed to higher temperatures (e.g., higher temperatures than the boiling point of LNG). As ambient temperature increases, LNG within the tank may evaporate as a boil-off gas, creating increasing pressure within the cryogenic tank.

Thus, to address the increasing pressure within the cryogenic tank, the boil-off gas may be released from the tank, for example, through a valve. In some systems, the boil-off gas may be vented directly to the atmosphere. However, venting the boil-off gas to the atmosphere has drawbacks and undesirable effects.

### BRIEF DESCRIPTION

In one embodiment, a system is provided including a heat exchanger, a detection unit, and a controller. The heat exchanger includes a first passage and a second passage configured for exchange of heat therebetween. The first passage is configured to receive, at an inlet, a boil-off gas stream of a first cryogenic fluid from a first tank. The second passage is configured to receive, at an inlet, a liquid stream of a second cryogenic fluid from a second tank. The second cryogenic fluid has a lower evaporation temperature than the first cryogenic fluid. The detection unit is configured to detect a characteristic of the boil-off gas stream. The controller is configured to acquire information from the detection unit corresponding to the characteristic. The controller is also configured to, responsive to the information acquired from the detection unit, control the flow of the second cryogenic fluid from the second tank to provide sufficient exchange of heat from the boil-off gas stream via the heat exchanger to condense at least a portion of the boil-off gas stream, whereby a liquid stream of the first cryogenic fluid is output from the first passage and returned to the first tank.

In another embodiment, a method is provided for re-condensing a boil-off gas stream of a first cryogenic fluid from a first tank. The method includes receiving the boil-off gas stream at an inlet of a first passage of a heat exchanger. The method also includes determining, using information corresponding to a characteristic of the boil-off gas stream, a flow of a stream of a second cryogenic fluid from a second tank through a second passage of the heat exchanger to condense at least a portion of the boil-off gas stream as the boil-off gas stream passes through the first passage. Further, the method includes receiving the stream of the second cryogenic fluid at an inlet of the second passage of the heat exchanger. The method further includes condensing at least a portion of the boil-off gas stream to provide a liquid stream of the first cryogenic fluid from an outlet of the first passage of the heat exchanger, and returning the liquid stream of the first cryogenic fluid to the first tank.

In another embodiment, a tangible and non-transitory computer readable medium is provided. The tangible and non-transitory computer readable medium includes one or more computer software modules configured to direct at least one processor to determine, using information corresponding to a characteristic of a boil-off gas stream of a first cryogenic fluid from a first tank configured to enter a first passage of a heat exchanger, a flow of a stream of a second cryogenic fluid from a second tank through a second passage of the heat exchanger to condense at least a portion of the boil-off gas stream as the boil-off gas stream passes through the first passage. The one or more computer software modules are also configured to direct the at least one processor to direct the stream of the second cryogenic fluid into an inlet of the second passage of the heat exchanger, whereby at least a portion of the boil-off gas stream is condensed to provide a liquid stream of the first cryogenic fluid from an outlet of the first passage of the heat exchanger as the boil-off gas stream passes through the first passage. Further, the one or more computer software modules are configured to direct the at least one processor to direct the liquid stream of the first cryogenic fluid to the first tank.

### BRIEF DESCRIPTION OF THE DRAWINGS

FIG. 1 is a schematic view of a system for re-condensing boil-off gas from a cryotank in accordance with various embodiments.

FIG. 2 is a graph of mass flow rates in accordance with various embodiments.

FIG. 3 is a graph of required liquid nitrogen mass in accordance with various embodiments.

FIG. 4 is a graph of required liquid nitrogen volume in accordance with various embodiments.

FIG. 5 is a schematic view of a system for re-condensing boil-off gas from a cryotank in accordance with various alternate embodiments.

FIG. 6 is a schematic illustration of an embodiment of a system for oxidizing boil-off gas disposed within an aircraft in accordance with various embodiments.

FIG. 7 is a flowchart of a method for oxidizing boil-off gas from a cryotank in accordance with various embodiments.

### DETAILED DESCRIPTION

Various embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors, controllers or memories) may be implemented in a single piece of hardware (e.g., a general purpose signal processor or random access memory, hard disk, or the like) or multiple pieces of hardware. Similarly, any programs may be stand-alone programs, may be incorporated as subroutines in an operating system, may be functions in an installed software package, and the like. It should be understood that the various embodiments are not limited to the arrangements and instrumentality shown in the drawings.

As used herein, the terms “system,” “unit,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. The modules or units shown in the attached figures may represent the hardware that operates based on software or hardwired instructions, the software that directs hardware to perform the operations, or a combination thereof. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Generally, various embodiments provide for reduced emission of combustible gases and/or otherwise potentially harmful emissions, while providing for relatively compact, lightweight cryogenic tanks and re-condensing systems that are configured to condense and return a boil-off gas stream of a cryogenic fluid to a cryotank. For example, in some embodiments, a boil-off gas of a first cryogenic fluid may be passed through a first passage of a heat exchanger, while a liquid stream of a second cryogenic fluid may be passed through a second passage of the heat exchanger. The second cryogenic fluid may be at a lower temperature than the first cryogenic fluid and have a lower evaporation temperature than the first cryogenic fluid. For example, in some embodiments, the boil-off gas stream may be a stream from a first cryogenic fluid used as fuel onboard an aircraft. For example, the first cryogenic fluid may be liquid natural gas (LNG). The second cryogenic fluid, for example, may be liquid nitrogen (LN₂). As the first cryogenic fluid is passed through the heat exchanger, heat from the boil-off gas of the first cryogenic fluid is transferred to the second cryogenic fluid, thereby condensing the boil-off gas to a liquid that may be returned to a first tank holding the first cryogenic fluid (e.g., the cryogenic fluid providing fuel, for example, for an aircraft) from which the boil-off gas was produced. In some embodiments, the second cryogenic fluid may be evaporated as the second cryogenic fluid passes through the second passage of the heat exchanger. Further still, in some embodiments, the resulting exhaust gas stream of the second cryogenic fluid may be used to at least one of purge or inert a functional component of an aircraft system. In some embodiments, the second cryogenic fluid may remain in a liquid state as the second cryogenic fluid passes through the second passage, and a return stream of the second cryogenic fluid may be returned to a second tank from which the liquid stream of the second cryogenic fluid was originally obtained. In some embodiments, the resulting exhaust gas stream of the second cryogenic fluid may be vented to the atmosphere.

Various embodiments are provided for re-condensing a boil-off gas of a cryogenic fluid (e.g., LNG) stored in a cryotank, for example on-board an aircraft. At least one technical effect of various embodiments is a relatively lightweight system for handling boil-off gas. At least one technical effect of various embodiments provides for the treatment of boil-off gases using a system that requires little or no external power, for example, from an aircraft on which a cryotank system is disposed. At least one technical effect of various embodiments is reduction or elimination of harmful or otherwise undesirable emissions from boil-off gas. At least one technical effect of various embodiments is the production of an exhaust gas stream (e.g., a nitrogen stream) that may be used to purge or inert a functional component (e.g., an evaporator, a fuel tank, or the like) of an aircraft system. At least one technical effect of various embodiments include the conservation of a fuel (e.g., LNG). At least one technical effect of various embodiments is to reduce pressure within a cryogenic tank and/or provide for the use of a lighter cryogenic tank.

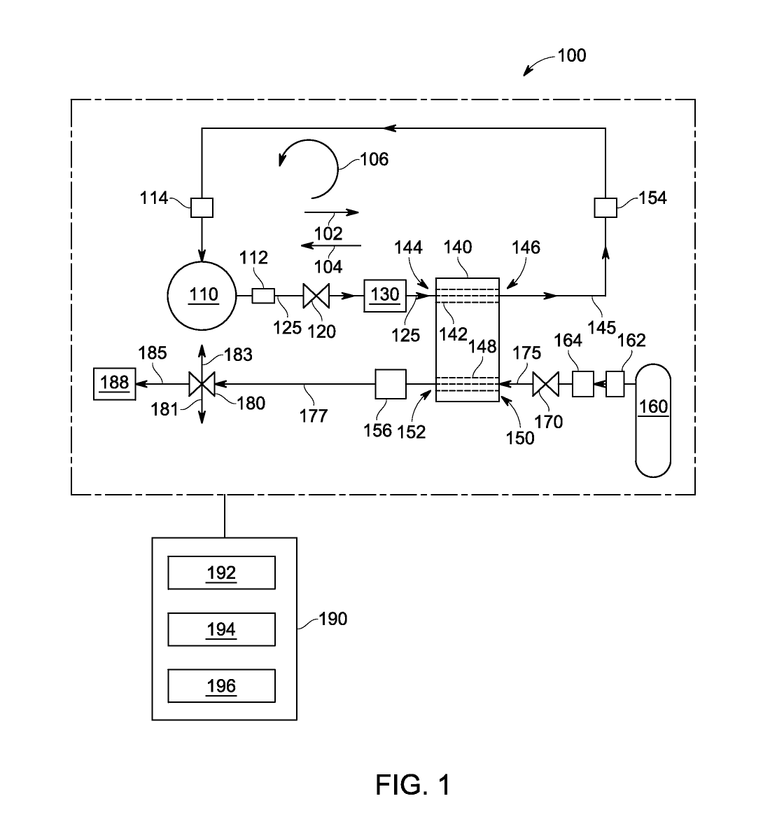

FIG. 1 is a schematic view of a system 100 formed in accordance with an embodiment. The system 100 (along with other embodiments of systems and methods described herein) is discussed below in connection with the use of liquid natural gas (LNG) as a source of power, for example, for propulsion of an aircraft. In other embodiments, other fuels may be used and/or alternate applications may be powered. The illustrated system 100 includes a first cryotank 110, a control valve 120, a boil-off detection module 130, a heat exchanger 140, a second cryotank 160, a second control valve 170, a splitter valve 180, and a controller 190. A functional module 188, which may receive a fluid (e.g., nitrogen gas) exhausted from the heat exchanger 140 is also depicted in FIG. 1.

Generally, boil-off gas (or a gas or other product formed using the boil-off gas) from the first cryotank 110 is passed in a downstream direction 102 through aspects of the system 100. (An upstream direction 104 may be understood as the opposite direction of the downstream direction.) As the boil-off gas (or a gas or other product formed using the boil-off gas) passes through various aspects of the system, the boil-off gas (or a gas or other product formed using the boil-off gas) in the illustrated embodiment is condensed for return to the first cryotank 110. The first cryogenic fluid (e.g. natural gas) may be understood as passing through a circuit 106 from the first cryotank 110, through the heat exchanger 140, and back to the first cryotank 110.

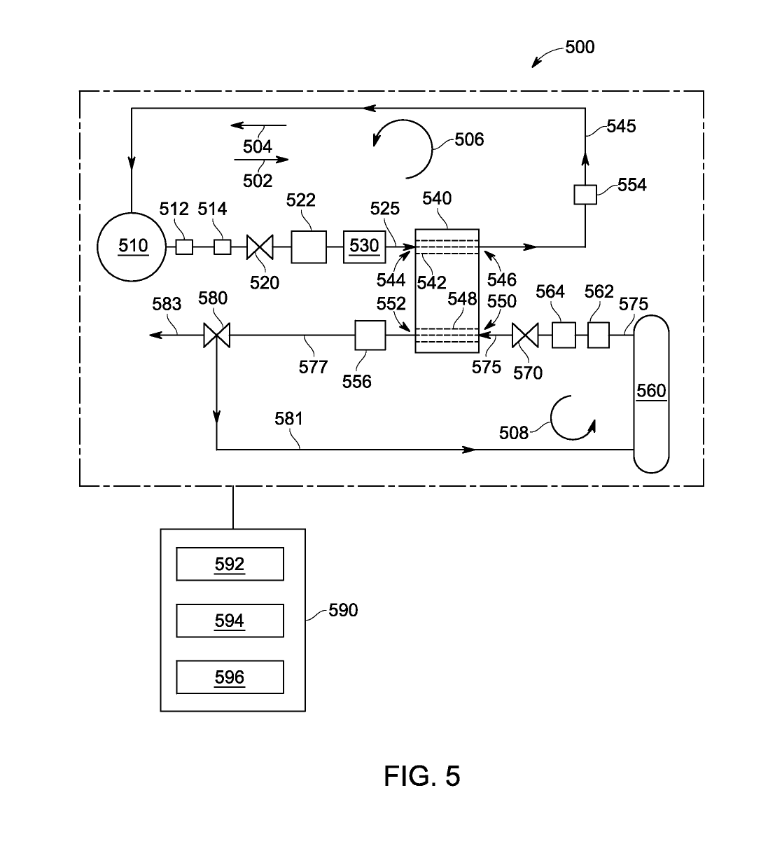

As seen in FIG. 1, the system 100 defines a downstream direction 102 and an upstream direction 104. The downstream direction 102 may be understood as the direction or path followed by boil-off gas (or products of boil-off gas) as the boil-off gas (or products of boil-off gas) is treated or processed. In the illustrated embodiment, boil-off gas flows from the cryotank 110 via the control valve 120 as a boil-off gas stream 125. The boil-off gas stream 125 flows in the downstream direction 102 to the boil-off detection module 130. At the boil-off detection module 130, one or more properties or characteristics (e.g., one or more of flow, temperature, pressure, velocity, or the like) of the boil-off gas stream 125 is detected. Information regarding the one or more properties or characteristics of the boil-off gas stream 125 is provided to the controller 190, with the controller 190 then determining a required flow (e.g., a threshold or minimum) of a second cryogenic fluid contained in the second cryotank 160 to condense at least a portion of the boil-off gas stream 125. As the boil-off gas stream 125 proceeds downstream from the boil-off detection module 130, the boil-off gas stream 125 enters the heat exchanger 140. In the illustrated embodiment, the heat exchanger 140 is configured as a condensing heat exchanger with a second cryogenic fluid from the second cryotank 160 absorbing heat from the boil-off gas stream 125 to condense the boil-off gas in the boil-off gas stream 125 to produce a liquid stream of the first cryogenic fluid which may be returned to the first cryotank 110. In some embodiments, the second cryogenic fluid may not be evaporated as the second cryogenic fluid passes through the heat exchanger, and returned to the second cryotank (see FIG. 5 and related discussion). In the embodiment depicted in FIG. 1, the second cryogenic fluid is evaporated as the second liquid passes through the heat exchanger 140, with an exhaust stream 177 of the second cryogenic fluid in a gaseous phase directed from the heat exchanger 140 toward the splitter valve 180. The splitter valve 180 may be configured to direct the gaseous exhaust stream 177 to, for example, the atmosphere and/or proximate to a functional module (e.g., functional module 188) of an aircraft system, where the exhaust stream 177 may be used, for example, to purge or inert one or more aspects of the functional module 188. The controller 190 is configured to receive information regarding one or more streams or flows through the system 100, and to control the various flows or streams (e.g., by controlling the settings on one or more valves, pumps, or the like) through the system 100.

The first cryotank 110 in the illustrated embodiment is used to contain a first cryogenic fluid. In various embodiments, the first cryogenic fluid contained by the at least one cryogenic tank 110 may be any type of cryogenic fluid (which may be contained within the first cryogenic tank 110 in liquid and/or gaseous form), such as, but not limited to, LNG, CNG and/or the like. In some embodiments, the first cryogenic tank 110 is a fuel tank on-board an aircraft for containing LNG or another cryogenic fluid that is used as fuel for an engine of the aircraft. The first cryotank 110 (along with other aspects of the system 100) may be configured in some embodiments as a relatively permanent feature of an aircraft, while in other embodiments, the first cryotank 110 and other aspects of the system 100 may be configured as a generally stand-alone unit that may readily be loaded or un-loaded from an aircraft.

The first cryotank 110, in some embodiments includes a shell and an internal reinforcement frame (not shown). The shell may define an internal volume that is bounded by an interior side of the shell, and may be configured to contain the first cryogenic fluid within the internal volume. The first cryotank 110 thus may define a closed container configured to hold the first cryogenic fluid therein. The first cryotank 110 may define a pressure vessel that is configured to hold the first cryogenic fluid therein at a pressure that is different than ambient (e.g., atmospheric) pressure.

For example, as ambient temperature rises, LNG within the first cryotank 110 will evaporate, producing a boil-off gas. As the amount of boil-off gas increases, the pressure within the first cryotank 110 will increase. At some point, the pressure may become too large for the first cryotank 110. In the illustrated embodiment, the system 100 includes a tank sensor 112. The tank sensor 112 is configured to sense or detect, directly or indirectly, when the pressure within the first cryotank 110 exceeds a desired or acceptable level (e.g., a level selected from a range beneath a maximum pressure for which the first cryotank 110 is designed to withstand or for which the first cryotank 110 is rated). For example, the tank sensor 112 may include a pressure sensor configured to measure or detect the pressure within the first cryotank 110.

The control valve 120 is configured to control a flow of boil-off gas out of the first cryotank 110 in the downstream direction 102 to the boil-off detection module 130 and the heat exchanger 140. In the illustrated embodiment, the control valve 120 is interposed between the first cryotank 110 and the boil-off detection module 130, and is disposed downstream of the cryotank 110 and upstream of the boil-off detection module 130. In some embodiments, the control valve 120 may be mounted inside, mounted to, or otherwise associated with the first cryotank 110. In the illustrated embodiment, when a pressure exceeding a threshold is detected by the tank sensor 112, the control valve 120 opens to allow passage of boil-off gas in the downstream direction 102 as the boil-off gas stream 125, thereby helping reduce the pressure in the first cryotank 110. In various embodiments, the boil-off gas may be passed from the first cryotank 110 at a pressure slightly higher than atmospheric pressure and at the saturation temperature of natural gas (which may be lower than ambient temperature). In some embodiments, the control valve 120 may be closed if the pressure in the first cryotank 110 drops below a threshold.

As the boil-off gas stream 125 travels downstream from the control valve 120, the boil-off gas stream 125 passes through, by, or otherwise proximate to the boil-off detection unit 130. The boil-off detection unit 130 is configured to sense or detect one or more characteristics or properties of the boil-off gas stream 125. For example, the boil-off detection unit 130 may directly measure a flow (e.g., mass flow or volume flow) of the boil-off gas stream 125. As another example, the boil-off detection unit 130 may measure or detect one or more of a pressure, velocity, temperature, or the like of the boil-off gas stream 125. Further, the one or more of a pressure, velocity, temperature, or the like of the boil-off gas stream 125 may be used to determine a flow of the boil-off gas stream 125 (e.g., the flow may be measured indirectly). In the illustrated embodiment, the boil-off detection unit 130 is depicted schematically as a single block. In various embodiments, more than one detection unit (e.g., sensor, detector, or the like) may be employed. Further, in some embodiments, all or a portion of the structure or functionality of the boil-off detection unit 130 may be shared or integrated with the tank sensor 112.

The boil-off detection unit 130 is configured to provide information corresponding to the detected one or more properties or characteristics to the controller 190. The controller 190 is configured to use the information regarding the boil-off gas stream 125 to determine a corresponding flow of a second cryogenic fluid through the heat exchanger 140 to condense the boil-off gas stream 125. The controller 190 may be configured to determine an amount of heat transfer required to change the phase of the boil-off gas stream 125 and/or to drop the temperature of the condensed boil-off gas stream by a given amount as the boil-off gas stream 125 passes through the heat exchanger 140. For example, using measured properties (e.g., the mass flow rate, temperature, or the like) of the boil-off gas stream, as well as inherent properties of the boil-off gas stream (e.g., saturation temperature, latent heat of evaporation, specific heat capacity, or the like), the controller 190 may determine an amount of heat that must be removed from the boil-off gas stream 125 to lower the temperature of the boil-off gas stream 125 to the saturation temperature or boiling point of the boil-off gas stream (if the temperature is initially higher than the saturation temperature), to condense the boil-off gas stream from gas to liquid, and, in some embodiments, to drop the temperature of the now liquid stream by about one degree Celsius (e.g., to help insure that substantially all of the boil-off gas passing through the heat exchanger 140 has condensed). The controller 190 may next determine a corresponding mass flow rate of a second cryogenic fluid to provide the required or desired cooling, using, for example, measured properties of the second cryogenic fluid (e.g., temperature) and inherent properties of the second cryogenic fluid (e.g., latent heat of evaporation, saturation temperature, specific heat capacity, or the like). The controller 190 may then direct a flow of the second cryogenic fluid through the heat exchanger 140 (e.g., via controlling the settings of one or more valves, pumps, or the like), monitor the heat exchange and condensing of the boil-off gas stream 125 (e.g., via one or more detectors positioned within or otherwise proximate to the heat exchanger 140), and make adjustments to the control of one or more aspects of the system 100 as appropriate to achieve a desired condensing and/or cooling of the boil-off gas stream 125.

In one example scenario, the first cryogenic fluid is LNG stored in the first cryotank 110, and the boil-off gas stream 125 is composed of natural gas in a gaseous phase resulting from boil-off of LNG from the first cryotank 110. Further, the second cryogenic fluid is LN₂ stored in the second cryotank 160, and provided as a liquid stream 175 from the second cryotank 160 to the heat exchanger 140. The saturation temperature or boiling point of LNG at about atmospheric pressure is about 113 degrees Kelvin (K). The saturation temperature or boiling point of LN₂ at about atmospheric pressure is about 77 degrees K. Thus, if the two streams (e.g., the boil-off gas stream 125 from LNG in the first cryotank 110, and a liquid stream 175 of LN₂ from the second cryotank 160) are provided at about the respective saturation temperatures or boiling points, the boil-off gas stream 125 will be at a higher temperature than the liquid stream 175. Thus, heat will be transferred from the boil-off gas stream 125 to the liquid stream 175. If enough heat is transferred from the boil-off gas stream 125 to the liquid stream 175, the boil-off gas stream 125 will be condensed.

Further, if both of the streams are at or about at the respective saturation temperatures, such that the heat transfer from the boil-off gas stream 125 to the liquid stream 175 will result in the condensing of the boil-off gas stream 125 as well as the evaporation of the liquid stream 175 without substantially changing the temperature of either stream (e.g., the specific heat capacity of each stream may be disregarded), then the mass flow of the LN₂ stream from the second cryotank 160 should be about twice the mass flow of the boil-off gas stream 125, as the latent heat of evaporation of natural gas is about twice the latent heat of evaporation of nitrogen. The ratio of mass flows desired or required may be adjusted, for example, if only a portion of the boil-off gas stream 125 is desired to be condensed (e.g., less mass flow rate of LN₂ required), if the temperature of the condensed boil-off gas stream 125 is desired to be substantially reduced below the saturation temperature (e.g., more mass flow rate of LN₂ required), or the like. Thus, in such an example scenario, the controller 190 may determine the mass flow rate of the boil-off gas stream 125, determine an appropriate mass flow rate of the second cryogenic fluid (e.g., LN₂) from the second cryotank 160 to be about twice the mass flow rate of the boil-off gas stream 125, and control the system 100 (e.g., one or more pumps or valves associated with the second cryotank 160) to provide the desired mass flow rate of the liquid stream 175 from the second cryotank 160. Additional mass flow rate of LN₂ may be provided to account for inefficiencies in the system, provide a safety factor to insure condensation of substantially the entire boil-off gas stream passing through the heat exchanger, lower the temperature of the condensed boil-off gas, or the like.

In the illustrated embodiment, the flow of the second cryogenic fluid (e.g., LN₂) is provided from the second cryotank 160. The second cryotank 160 may be similar to the first cryotank 110 in certain respects. In the illustrated embodiment, the second cryotank 160 may be substantially smaller in capacity than the first cryotank 110. For example, in some embodiments, the system 100 may include one or more first cryotanks 110 having a combined capacity of over about 10,000 gallons. The second cryotank 160, which is sized to provide sufficient cryogenic fluid (e.g. LN₂) to condense the boil-off gas from the one or more first cryotanks, may be substantially smaller, for example, about 200 gallons or less in some embodiments. The second cryotank 160, in some embodiments, is dedicated exclusively for use with the system 100 for re-condensing boil-off gas from the first cryotank 110, while, in other embodiments, the second cryotank 160 may be shared with other systems. For example, the second cryotank 160 may be used to provide LN₂ to the heat exchanger 140 as well as to provide LN₂ (or a stream of nitrogen gas from the LN₂) directly to a different system (e.g., a purging or inerting system). For example, LN₂ (or a stream of nitrogen gas) from the second cryotank may be provided to a different system of an aircraft without passing through the heat exchanger 140 (e.g., to inert a jet fuel tank, to purge one or more components of a system, or the like).

The system 100 also includes a detector 162 and a pressurization module 164 disposed proximate to the second cryotank 160. The detector 162 is depicted schematically as a single block but may include more than one detectors or sensors. The detector 162 is configured to sense or detect one or more properties or characteristics of the liquid stream 175 leaving the second cryotank 160 (e.g., mass or volumetric flow rate, velocity, temperature, pressure, or the like) and to provide corresponding information to the controller 190. The controller 190 may use the information to determine an appropriate flow rate for the liquid stream 175 and/or to monitor the liquid stream 175.

In some embodiments, the LN₂ may be at a sufficient pressure that the liquid stream 175 may be provided from the second cryotank 160 without an additional component providing a pressure gradient. In the illustrated embodiment, the system 100 includes a pressurization module 164 configured to provide a pressure gradient configured to direct a desired amount of the second cryogenic fluid (e.g., LN₂) in the liquid stream 175 from the second cryogenic tank 160 to the heat exchanger 140. For example, the pressurization module 164 may be a pump operated under the control of the controller 190. In one example scenario, when the controller 190 determines that an increased mass flow rate of the liquid stream 175 is desired to condense the boil-off gas stream 125, the pumping effort of the pressurization module 164 (e.g., a pump) may be increased. In another example scenario, when the controller 190 determines that a decreased mass flow rate of the liquid stream 175 may be sufficient to condense the boil-off gas stream 125, the pumping effort of the pressurization module 164 (e.g., a pump) may be reduced. The pressurization module 164 is shown in the illustrated embodiment disposed downstream (in terms of the flow of the second cryogenic fluid) from the second cryogenic tank 160. In other embodiments, for example, a pump may be disposed within the second cryogenic tank 160. In still other embodiments, a pump or other pressurization module 164 may not be required or utilized to direct the flow of the second cryogenic fluid.

The depicted system 100 also includes a control valve 170 interposed between the second cryogenic tank 160 and the heat exchanger 140. The control valve 170 is configured to control the flow of the liquid stream 175 from the second cryogenic tank 160 to the heat exchanger 140. For example, settings of the control valve 170 may be controlled by the controller 190 to allow a desired amount of flow of the liquid stream 175 through the control valve 170 to the heat exchanger 140. The control valve 170 (additionally or alternatively to the pressurization module 164) may be configured to be controlled by the controller 190 to provide a desired flow of the liquid stream 175.

In one example scenario, when the controller 190 determines that an increased mass flow rate of the liquid stream 175 is desired to condense the boil-off gas stream 125, the control valve 170 may be set to allow a higher flow of the liquid stream 175 to pass to the heat exchanger 140. In another example scenario, when the controller 190 determines that a decreased mass flow rate of the liquid stream 175 may be sufficient to condense the boil-off gas stream 125, the control valve 170 may be set to allow a lesser amount of flow of liquid stream 175 to pass to the heat exchanger 140 (e.g., to conserve LN₂). As also discussed herein, in embodiments where the system 100 is configured to raise a temperature of the liquid stream 175 without evaporating the liquid stream 175, an increased amount of flow (compared to when the liquid stream 175 is evaporated) of the liquid stream 175 may be required to be provided by the pressurization module 164 and/or permitted by the control valve 170.

The boil-off gas stream 125 (from the first cryotank 110) and the liquid stream 175 (from the second cryotank 160) each advance to and through the heat exchanger 140. The heat exchanger 140 is configured to transfer a sufficient amount of heat from the boil-off gas stream 125 to the liquid stream 175 to condense at least a portion of the boil-off gas stream 125 to provide a return stream 145 including the condensed boil-off gas (e.g., LNG). In some embodiments, substantially all of the boil-off gas steam 125 may be condensed to provide a return stream 145 that is substantially entirely liquid to the first cryotank 110. In some embodiments, the boil-off gas stream 125 may experience a phase change (e.g., condensation from a gaseous phase to a liquid phase) while the liquid stream 175 may not change phase. In the illustrated embodiment, both the boil-off gas stream 125 and the liquid stream 175 experience a phase change upon passage through the heat exchanger 140. Thus, the boil-off gas stream 125 may experience a phase change (e.g., condensation from a gaseous phase to a liquid phase) while the liquid stream 175 also experiences a phase change (e.g., evaporation from a liquid phase to a gaseous phase).

The heat exchanger 140 depicted in FIG. 1 includes a first passage 142 having an inlet 144 and an outlet 146, and a second passage 148 having an inlet 150 and an outlet 152. The first and second passages 142, 148 are configured to provide heat exchange between streams passing through the respective passages. One or more of the first and second passages 142, 148, for example, may be configured as a coil surrounding or passing proximately to the other of the passages. The heat exchanger 140 may be configured as a shell-and-tube heat exchanger in some embodiments. Other arrangements may be utilized for the heat exchanger 140 in various embodiments. In general, the heat exchanger 140 is sized and configured to provide sufficient flow of the liquid stream 175 and the boil-off gas stream 125 and sufficient heat exchange therebetween to condense a desired amount of the boil-off gas stream.

The boil-off gas stream 125 passes in the downstream direction 102 to the inlet 144 of the first passage 142. The boil-off gas stream 125, in some embodiments, may enter the inlet 144 as a super-heated vapor, and may exit the outlet 146 as a saturated liquid or a sub-cooled liquid. As the boil-off gas stream 125 passes through the first passage 142, the boil-off gas stream exchanges heat to the liquid stream 175 (in the second passage 148) in an amount sufficient to condense the boil-off gas stream (e.g, the controller 190 operates the system 100 to provide a sufficient liquid stream 175 to condense the boil-off gas stream 125). The condensation of the boil-off gas stream produces a return stream 145 of the first cryogenic fluid in a liquid state (e.g., LNG) that is directed to the first cryogenic tank 110 to replenish the first cryogenic tank 140. Thus, embodiments provide for the conservation of a fuel (e.g., LNG) while also preventing or reducing harmful or otherwise undesirable emissions from boil-off gas (e.g., greenhouse emissions or combustible emissions).

As the return stream 145 (e.g., LNG resulting from the condensation of the boil-off gas stream 125) exits the outlet 146 of the heat exchanger 140, the return stream 145 passes through a return stream detector 154. The return stream detector 154 is configured to detect one or more of a flow, temperature, velocity, pressure, or the like of the return stream 145. Information from the return stream detector 154 may be provided to the controller 190, and the controller 190 may adjust or otherwise control operation of the system 100 responsive to the information acquired from the return stream detector 154. For example, the controller 190 may determine an initial flow of the liquid stream 175 to condense the boil-off gas stream 125 and to provide a desired temperature of the return stream 145. If, however, the return stream detector 154 provides information to the controller 190 indicating that the return stream 145 is not substantially condensed and/or is at a higher temperature than desired, the controller 190 may adjust one or more settings of a pump or control valve associated with the liquid stream 175 to increase the flow of the liquid stream 175 through the heat exchanger 140. As another example, if the return stream detector 154 provides information to the controller 190 indicating that the return stream 145 is at a lower temperature than desired or required, the controller 190 may adjust one or more settings of a pump or control valve associated with the liquid stream 175 to decrease the flow of the liquid stream 175 through the heat exchanger 140.

In some embodiments, a pressure gradient and/or gravity provided from the build-up of boil-off gas within the first cryotank 110 may be sufficient to cause the passage of the first cryogenic fluid (e.g., the boil-off gas stream 125 and the return stream 145) from the first cryotank 110 through the heat exchanger 140 and back to the first cryotank 110. In other embodiments, a pressurization module or device (e.g., a pump or fan) configured to provide a pressure gradient through at least a portion of the circuit 106 may be used. In the illustrated embodiment, the system 100 includes a pressurization module 114 disposed proximate the first cryotank 110 and downstream of the heat exchanger 140 (e.g., at a point along the circuit 106 near the point where the return stream 145 is returned to the first cryotank 110). In the illustrated embodiment, the pressurization module 114 is configured as a pump for directing the movement of the return stream 145, which is in a liquid state. In alternate embodiments, a different type or location of pressurization module may be employed additionally or alternatively. For example, in some embodiments, alternatively or additionally, a pressurization module 114 may be disposed downstream of the first cryotank 110 and upstream of the heat exchanger 140, and be configured as a fan for directing the movement of the boil-off gas stream 125 which is in a gaseous state. In various embodiments, pressurization modules may be configured as one or more of a blower, compressor, or the like. The pressurization module 114 may be operably connected to and operate under the control of the control module 190. In some embodiments, where the first cryotank 110 is sufficiently robust to provide the required pressure gradient to move the various streams through the circuit 106, a pressurization module may not be used. For example, a gradient may be established in a tank from local pressure differences that may arise between various areas in the tank, such as between the top and bottom parts of the tank. Further still, in various embodiments, the first cryotank 110 may be configured to include tank features that enhance such pressure gradients. In other embodiments, one or more pressurization modules may be employed along the circuit 106, allowing the system 100 to operate with lower pressures in the first cryotank 110, thereby allowing for a generally lighter and/or simpler design of the first cryotank 110.

Returning to the heat exchanger 140, the liquid stream 175 enters the inlet 150 of the second passage 148. In some embodiments, the liquid stream 175 may enter the inlet 150 as a sub-cooled or saturated liquid, and exit the outlet 152 as a saturated or super-heated vapor. As the liquid stream 175 passes through the second passage 148, heat from the condensing boil-off gas stream 125 is transferred to the liquid stream 175. The transferred heat may raise the temperature of the liquid stream 175 and/or cause a phase transformation or change (e.g., evaporation or boiling from a liquid state to a gaseous state) of the liquid stream 175. In the embodiment depicted in FIG. 1, the liquid stream 175 is evaporated as the liquid stream 175 passes through the second passage 148. The now evaporated liquid stream 175 passes out of the outlet 152 of the heat exchanger 140 as an exhaust stream 177 in gaseous form. For example, LN₂ from the second cryotank 160 may be evaporated upon passage through the heat exchanger and be exhausted from the heat exchanger as an exhaust stream of nitrogen gas. In some embodiments, the second cryogenic fluid may be maintained in the second cryotank 160 at or near the saturation temperature or boiling point so that most or all of the heat transferred to the second cryogenic fluid is used to change the state of the second cryogenic fluid from liquid to gas or to heat a gas that has been formed by evaporation or boiling. In various embodiments, the controller 190 may operate the system 100, including for example the amount of flow of the liquid stream 175 to the heat exchanger 140, so that the boil-off gas stream 125 and the liquid stream 175 are provided in a proportion selected to cause each stream to change phase substantially entirely upon passage through the heat exchanger with each stream leaving the heat exchanger at or near the saturation temperature or boiling point of the respective fluid (e.g., in some embodiments, within about one degree Celsius of the saturation temperature.)

As the exhaust stream 177 exits the heat exchanger, the exhaust stream 177 passes through the exhaust detector 156. The exhaust detector 156 is configured to detect one or more of a flow, temperature, velocity, pressure, or the like of the exhaust stream 177. Information from the exhaust detector 156 may be provided to the controller 190, and the controller 190 may adjust or otherwise control operation of the system 100 responsive to the information acquired from the exhaust detector 156. For example, if the exhaust stream 177 is at a higher temperature than desired, the controller 190 may control the system 100 to provide an increased flow of the liquid stream 175 from the second cryotank 160 to the heat exchanger 140. As another example, if the controller 190 determines from information provided by the exhaust detector 156 that the exhaust stream is not fully evaporated and/or is at a lower temperature than desired, the controller 190 may operate the system 100 to reduce the flow of the liquid stream 175 from the second cryotank 160.

As the exhaust stream 177 proceeds away from the heat exchanger 140, the exhaust stream reaches the splitter valve 180. The splitter valve 180 is configured to direct the exhaust stream along one or more paths. In the illustrated embodiment, the splitter valve 180 is controlled by controller 190, and is configured to direct the exhaust stream 177 to one or more of the first cryotank 110 (which provides an example of a functional component or module), the atmosphere, or the functional component 188. Settings of the splitter valve 180 that determine the proportion of the exhaust stream 177 that is diverted along a given direction may be determined and/or controlled by the controller 190.

For example, all or a portion of the exhaust stream 177 may be directed through the splitter valve 180 as a vent stream 181 that is discharged to the atmosphere. Further, all or a portion of the exhaust stream 177 may be directed through the splitter valve 180 as a tank stream 183. The tank stream 183 is directed toward the first cryotank 110, and may be used to purge the atmosphere surrounding the first cryotank 110. For example, the tank stream 183 may be discharged through one or more nozzles proximate an exterior of the first cryotank 110 and act as a stream or sheet of cleaning or diluting gas to help purge (e.g., remove or dilute) any potentially harmful leakage (e.g., natural gas leakage) from the first cryotank 110 or associated components (such as piping, valves, or the like).

A functional component to which an exhaust stream is directed may be part of a boil-off gas re-condensing system and/or a circuit of such a system (e.g., a cryotank), or may be external to a boil-off gas re-condensing system and/or a circuit of such a system (e.g., a jet fuel tank). For example, all or a portion of the exhaust steam 177 may be directed to one or more functional components 188 as one or more streams 185 (only one stream 185 is shown in the illustrated embodiment for the sake of clarity, however various embodiments may include additional streams and/or functional components). For example, in embodiments associated with an aircraft having a jet fuel tank, the functional component 188 may be a jet fuel tank. The stream 185 may be used to inert one or more jet fuel tanks, either acting alone or as a supplement to an additional inerting mechanism (not shown). Inerting of a jet fuel tank may be understood as providing nitrogen, nitrogen-enriched air, or the like to reduce the oxygen concentration within a fuel tank to a level at which ignition may not be supported by the flammable vapors. As another example, additionally or alternatively, the stream 185 (or an additional stream from the splitter valve 180 having the exhaust stream 177 as a source) may be used to purge an evaporator. In some embodiments, LNG from the first cryotank 110 may be directed toward a jet or other aircraft engine to be used as fuel. Before the LNG reaches the engine, however, the LNG must be changed to a gaseous state for proper operation of the engine. This change of state may be accomplished at an evaporator. For dual fuel engines, when the aircraft switches from LNG operation to jet fuel operation, a residual amount of natural gas may be left in the evaporator or elsewhere along an associated circuit. A purging flow of the stream 185 may be used to purge the combustible natural gas from the evaporator and/or related circuit. As one more example, a purging flow of the stream 185 may be directed to a volume surrounding or otherwise proximate to electrical wires that may be exposed to natural gas. The above embodiments are provided by way of example and not limitation, as the exhaust stream 177 may be directed to one or more additional or alternative functional components in various embodiments. As another example, embodiments may be used in connection with engines that are configured to utilize a single fuel, such as LNG.

As also indicated above, the controller 190 may be operably connected to and configured to control operations of the various components of the system 100. For example, the controller 190 may acquire information corresponding to the flow of boil-off gas (e.g., one or more of a flow, temperature, or pressure of a boil-off gas stream), determine a flow of a second cryogenic fluid (e.g. LN₂) to absorb a sufficient amount of heat to condense the flow of boil-off gas, and control the various components of the system to provide the required flow to the heat exchanger and operate the system so that the boil-off gas is condensed in the heat exchanger 140. The controller 190 may be configured as a computer processor or other logic-based device that performs operations based on one or more sets of instructions (e.g., software). The instructions on which the controller 190 operates may be stored on a tangible and non-transitory (e.g., not a transient signal) computer readable storage medium, such as a memory 196. The memory 196 may include one or more computer hard drives, flash drives, RAM, ROM, EEPROM, and the like. Alternatively, one or more of the sets of instructions that direct operations of the controller 190 may be hard-wired into the logic of the controller 190, such as by being hard-wired logic formed in the hardware of the controller 190.

The controller 190 of the illustrated embodiment includes a detection module 192, a control module 194, and a memory module 196 associated therewith. The detection module 192 is configured to receive information from sensors or detectors associated with the system (e.g., elements 112, 130, 154, 156, 162 discussed herein). The detection module 192 may also process the received information to determine one or more operating parameters of the system 100 (e.g., a flow to be provided (e.g., a flow of the liquid stream 175) and/or one or more settings of one or more components of the system 100 (e.g., a pump, a fan, a valve, or the like) to achieve the desired flow). The control module 194 is configured to receive information from the detection module 192 and to control operation of the system 100 responsive to the received information. For example, the control module 194 may be configured to open, close, or adjust one or more valve settings to adjust flow through the system, or, as another example, may be configured to control operation of one or more pumps or fans. By way of example, the controller 190 in the illustrated embodiment may, responsive to information received from sensors or detectors, control the amount of flow of the liquid stream 175 from the second cryotank 160, control the settings of the splitter valve 180 (e.g., to change the proportion of flow of exhausted gas (e.g., nitrogen gas) to one or more functional components to purge or inert the functional component(s)), control the settings of the control valve 120 (e.g., to permit or prohibit flow of boil-off gas from the first cryotank 110 responsive to a determined pressure of the first cryotank 110), or the like. As another example, the controller 190 may be configured to control settings of various valves or other components associated with the heat exchanger 140 to direct the various flows through the heat exchanger 140. The controller 190 may also receive information monitoring the output of one or more outlets of the heat exchanger, and adjust operation of the system as appropriate, for example, based on a difference in actual conditions of one or more streams leaving the heat exchanger from predicted conditions (e.g., a deviation in temperature or pressure, a stream exiting the heat exchanger in a different phase or state than expected or desired, or the like). In some embodiments, the controller 190 may also control or limit the flow of boil-off gas from the first cryotank 110 (provided that the pressure within the cryotank 110 is still maintained within an acceptable range) to help insure a desired pressure gradient for directing flow through the first circuit 106 and/or to conserve LN₂ during a portion of a flight or other mission (e.g., to provide more heat exchange between the boil-off gas stream and LN₂ at a time when an aircraft may have more need or use for an exhaust stream of nitrogen gas).

Thus, in various embodiments, a relatively compact and lightweight system may be provided that safely and effectively re-condenses boil-off gas and returns the condensed cryogenic fluid to a cryotank, thereby conserving a cryogenic fuel as well as reducing harmful or otherwise undesirable emissions. It should be noted that the particular arrangement of components (e.g., the number, types, placement, or the like) of the illustrated embodiment may be modified in various alternate embodiments. In various embodiments, different arrangements of components may be employed.

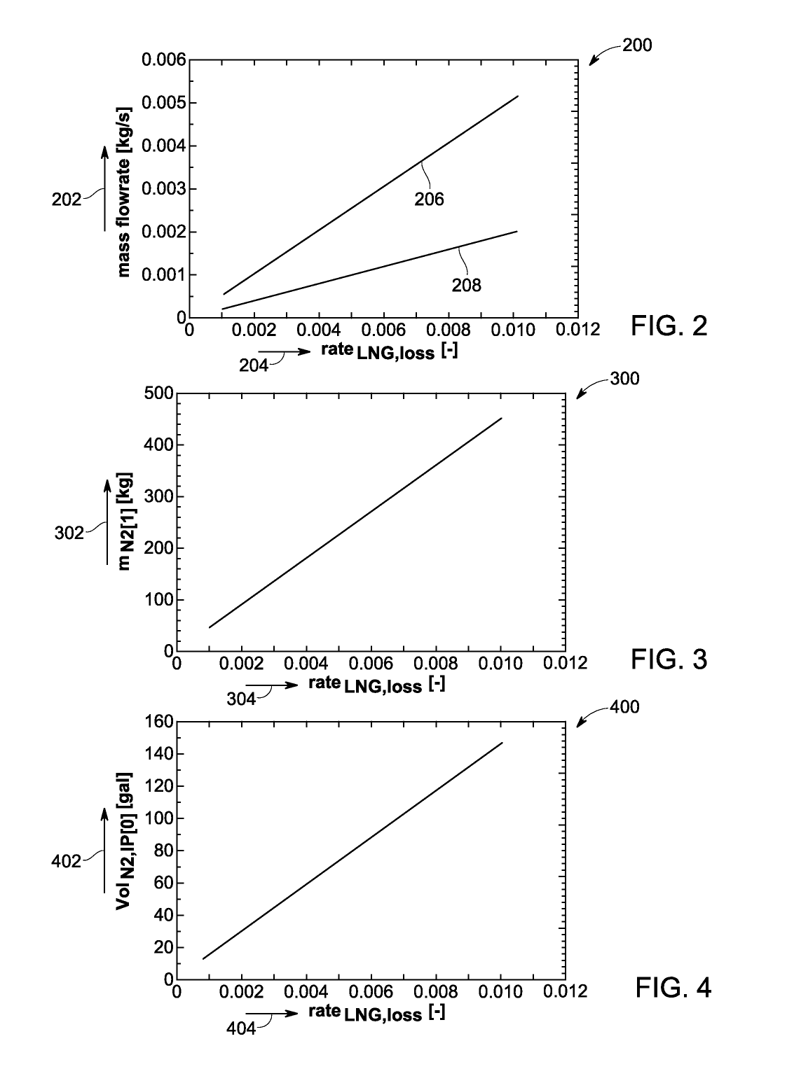

FIGS. 2-4 provide graphs depicting various flows or amounts of cryogenic fluids employed over a range of boil-off loss rates in various embodiments. The embodiments depicted in FIGS. 2-4 are based off of the use of LNG as the first cryogenic fluid (e.g., the fuel for which boil-off gas is condensed and returned to a tank) and LN₂ as the second cryogenic fluid (e.g., the fluid used to absorb heat from the LNG in a heat exchanger). In the depicted embodiment, both fluids undergo a phase change in the heat exchanger (e.g., the LNG boil-off gas is condensed and the LN₂ is evaporated to provide a nitrogen gas exhaust stream that exits the heat exchanger).

A number of values and/or assumptions were used in developing FIGS. 2-4. For example, the embodiments depicted in FIGS. 2-4 correspond to an initial volume of about 11,000 gallons of LNG. The 11,000 gallons may be contained in a single tank. Alternatively, the 11,000 gallons may be contained in a group of tanks operably connected to one or more boil-off condensation systems as discussed above. For example, one or more tanks having a storage volume of about 4,000 to 5,000 gallons or less may be used in various embodiments. A group of tanks may share a common boil-off condensation system in some embodiments, while in other embodiments each tank may be associated with and exclusively use a dedicated boil-off condensation system. The particular values discussed in connection with FIGS. 2-4 are provided by way of example, as other sizes of tanks and/or boil-off rates, for example, may be present in various embodiments.

Further, for FIGS. 2-4, ranges of boil-off rates of about 0.1% to about 1.0% (or about 0.001 to about 0.01) for a 24 hour period are depicted. The boil-off rate is assumed constant over the 24 hour period for the purposes of FIGS. 2-4, so that the boil-off rate sets a boil-off flowrate as well as the total mass for the 24 hour period. Further, it is assumed that the nitrogen is expended from the system after passage through the heat exchanger. The total energy needed to condense the boil-off stream was determined as the enthalpy change from 1 degree Celsius above T_{sat[LNG]} to 1 degree Celsius below T_{sat[LNG]} for the mass of LNG corresponding to the particular flowrate, where T_{sat[LNG]} is the saturation temperature of LNG, and the LNG being condensed at about 1 atmosphere of pressure. Thus, an energy required to condense the mass of LNG corresponding to a particular flow (e.g., a given boil-off rate for an initial volume over a range of time, such as a 1% flowrate for an 11,000 gallon initial volume over 24 hours) may be determined. A flow rate of nitrogen may then be determined to provide the required energy that has been determined as discussed above. For example, the energy available for a given flow rate of nitrogen to absorb the required energy may be understood as the enthalpy change from 1 degree Celsius below T_{sat[LN2]} to 1 degree Celsius above T_{sat[LN2]} for the mass of L LN₂ corresponding to the particular flowrate, where T_{sat[LN2]} is the saturation temperature of LN₂, with the LN₂ being evaporated at about 1 atmosphere of pressure. It may be noted that the above assumptions do not account for any losses or inefficiencies in heat transfer, so that an increased flow of LN₂ than provided by the above methodology may be required. The above assumptions also assume that the natural gas and nitrogen are maintained within about 1 degree Celsius of the respective saturation temperatures. Other methodologies may be used to determine a desired required nitrogen flow in other embodiments. For example, adjustments may be made for efficiencies, differing shifts in temperature before or after a phase change may be employed, or the like. Further, in embodiments, the flow may be calculated iteratively or adjusted using information acquired by a control unit (e.g., by providing an initial flow, determining the deviation of one or more parameters (e.g., temperature of a flow exiting the heat exchanger) from a desired level, and adjusting the flow accordingly).

FIG. 2 depicts a graph 200 including a first axis 202 corresponding to a mass flowrate (in kilograms/second (kg/s) and a second axis 204 corresponding to a rate of LNG boil-off loss. As depicted in FIG. 2, the rates of LNG boil-off loss vary from about 0.001 (or 0.1% of the total LNG over 24 hours) to about 0.01 (or 1.0%). FIG. 2 also depicts a LN₂ flow curve 206 and a LNG flow curve 208. The LNG flow curve 208 as discussed above, is based on the amount of LNG for a given loss rate for an initial volume of about 11,000 gallons. The LN₂ flow curve 206 is determined as the amount of LN₂ required to absorb energy sufficient to condense the amount of LNG for a given loss rate using the assumptions discussed above. As the latent heat of evaporation for LNG is greater than that for LN₂, the LN₂ flow rate is seen to be higher than the LNG flowrate.

FIG. 3 depicts a graph 300 including a first axis 302 corresponding to the total mass of nitrogen (in kilograms (kg)) required for the LN₂ flow curve 206 of FIG. 2 over a 24 hour period, and a second axis 304 corresponding to a rate of LNG boil-off loss. For example, at a boil-off loss of about 0.001 (or about 0.1%), as shown in FIG. 2, the LN₂ mass flowrate is about 0.0005 kg/s (as shown by the LN₂ flow curve 206). Over a 24 hour period, about 0.0005 kg/s results in a total mass of (0.0005 kg/s)×(60 s/minute)×(60 minute/hour)×(24 hours), or 43.2 kg (or about 45 kg (about 100 pounds)). As shown in FIG. 3, using the assumptions discussed above, for a boil-off rate loss of about 0.01 (or about 1%) and an initial volume of about 11,000 gallons of LNG, the best case mass (e.g., ignoring any inefficiencies or heat transfer losses) required for nitrogen is about 450 kg, or about 1,000 pounds. Also, FIG. 4 depicts a graph 400 including a first axis 402 corresponding to the total volume of LNG (in gallons (gal)) required for a the LN₂ flow curve 206 of FIG. 2 over a 24 hour period, and a second axis 404 corresponding to a rate of LNG boil-off loss. For example, at a boil-off loss of about 0.01, as shown in FIG. 2, the corresponding LN₂ mass is about 450 kg, as shown in FIG. 3 and discussed above. As shown in FIG. 4, using the assumptions discussed above, for a boil-off rate loss of about 1% and an initial volume of about 11,000 gallons of LNG, the best case LN₂ volume (e.g., ignoring any inefficiencies or heat transfer losses) required for nitrogen is about 150 gallons. As shown in FIG. 4, if the boil-off rate loss is about 0.1%, then the volume of nitrogen required is less, about 15 gallons. Thus, if all the nitrogen is expended after passage through the heat exchanger (e.g., no nitrogen is re-cycled to a nitrogen storage tank for repeated use in a boil-off gas re-condensation system), a nitrogen storage tank for the above example range would have to be sized to contain at least about 15-150 gallons. The nitrogen tank may be sized larger to account for inefficiencies and/or provide a safety factor.

The embodiments depicted in FIGS. 2-4 are provided by way of example and clarity of illustration, and are not intended as limiting. Various embodiments may include different initial volumes, have different boil-off loss rates (e.g., in some embodiments loss rates of about 0.04% or lower may be employed), utilize different fluids than LNG and/or LN₂, utilize different temperature shifts, utilize different pressures, have different overall time frames, have different corresponding ranges of tank sizes, or the like. Further, adjustments may be made to account for inefficiencies or heat transfer losses throughout a system.

Further, in some embodiments, a closed loop non-phase change circuit may be employed with the LN₂ (or other fluid used to absorb heat from a boil-off gas stream). For example, in some embodiments, LN₂ may be provided at a substantially lower temperature than the saturation temperature of nitrogen, and be warmed as the LN₂ passes through a heat exchanger without undergoing a phase change. In such embodiments, larger LN₂ flows may be used, as the enthalpy change for a relatively low rise in temperature is generally lower than an enthalpy change for a change in phase or state (e.g., evaporation or boiling from a liquid phase to a gaseous phase). For example, if an LNG stream is warmed about 20 degrees Celsius, the determined flow is about 6 times the corresponding flow determined using the assumptions corresponding to the embodiments depicted in FIGS. 2-4. Thus in some embodiments, for an initial volume of about 11,000 gallons of LNG and boil-off rates between about 0.1% and about 1%, a nitrogen mass of about 240 to about 2400 kg may be required. However, because the nitrogen may be re-used as part of a closed loop system, the volume of nitrogen required (and required nitrogen tank size) may not necessarily increase in the same relative proportion.

An example system utilizing a closed loop non-refrigerated circuit to provide a cryogenic fluid to absorb heat from a boil-off gas is shown schematically in FIG. 5. FIG. 5 is a schematic view of a system 500 for re-condensing boil-off gas from a cryotank in accordance with various embodiments. The system 500 is similar in certain respects to the system 100 depicted in FIG. 1 and discussed herein. However, the system 500 differs in certain respects as well. For example, the system 500 utilizes a pressurization module (e.g. a fan) disposed upstream of the heat exchanger and configured to advance the boil-off gas stream to the heat exchanger. As another example, the system 500 utilizes a closed loop circuit to recirculate a cryogenic fluid (e.g., LNG) used to absorb heat from a boil-off gas stream to a tank. In some embodiments, the system 500 may provide for cooling of one or more streams being returned to a tank, and in other embodiments the system 500 may not provide for cooling of one or more stream being returned to a tank.

The system 500 (along with other embodiments of systems and methods described herein) is discussed below in connection with the use of liquid natural gas (LNG) as a source of power, for example, for propulsion of an aircraft. In other embodiments, other fuels may be used and/or alternate applications may be powered. The illustrated system 500 includes a first cryotank 510, a control valve 520, a fan 522, a boil-off detection module 530, a heat exchanger 540, a second cryotank 560, a second control valve 570, a splitter valve 580, and a controller 590.

Generally, boil-off gas (or a gas or other product formed using the boil-off gas) from the first cryotank 510 is passed in a downstream direction 502 through aspects of the system 500. (An upstream direction 504 may be understood as the opposite direction of the downstream direction.) As the boil-off gas (or a gas or other product formed using the boil-off gas) passes through various aspects of the system, the boil-off gas (or a gas or other product formed using the boil-off gas) in the illustrated embodiment is condensed for return to the first cryotank 510. The first cryogenic fluid (e.g. natural gas) may be understood as passing through a circuit 506 from the first cryotank 510, through the heat exchanger 540, and back to the first cryotank 510.

The boil-off gas is condensed in the heat exchanger 540 via a transfer of heat to a second cryogenic fluid that is passed through the heat exchanger 540. In the system 500 depicted in FIG. 5, the second cryogenic fluid may be maintained in a liquid state throughout a passage through the heat exchanger 540, and may be returned to a second cryogenic tank 560 that is the source of the second cryogenic fluid. The second cryogenic fluid (e.g., LN₂) may be understood as passing through a second circuit 508 from the second cryotank 560, through the heat exchanger 540, and back to the second cryotank 560. In some embodiments, the second circuit 508 may be devoid of refrigeration or other means of cooling the second cryogenic fluid returned to the second cryogenic tank 560 from the heat exchanger 540. In some embodiments, the second cryogenic fluid may be re-circulated as a liquid one or more times through the heat exchanger 540 without a change in state until the saturation temperature of the second cryogenic fluid is reached. Once the saturation temperature of the second cryogenic fluid is reached, the second cryogenic fluid may be evaporated or boiled during passage through the heat exchanger, with the resulting exhaust (e.g., nitrogen gas) vented to the atmosphere and/or directed to a functional component of an aircraft.

As seen in FIG. 5, the system 500 defines a downstream direction 502 and an upstream direction 504. The downstream direction 502 may be understood as the direction or path followed by boil-off gas (or products of boil-off gas) as the boil-off gas (or products of boil-off gas) is treated or processed. In the illustrated embodiment, boil-off gas flows from the cryotank 510 via the control valve 520 as a boil-off gas stream 525. The boil-off gas stream 525 flows in the downstream direction 502 to the boil-off detection module 530. At the boil-off detection module 530, one or more properties or characteristics (e.g., one or more of flow, temperature, pressure, velocity, or the like) of the boil-off gas stream. 525 is detected. Information regarding the one or more properties or characteristics of the boil-off gas stream 525 is provided to the controller 590, with the controller 590 then determining a required flow of a second cryogenic fluid (e.g., LN₂) contained in the second cryotank 560 to condense at least a portion of the boil-off gas stream 525. As the boil-off gas stream 525 proceeds downstream from the boil-off detection module 530, the boil-off gas stream 525 enters the heat exchanger 540. The second cryogenic fluid from the second cryotank 560 absorbs heat from the boil-off gas stream 525 to condense the boil-off gas in the boil-off gas stream 525 to produce a liquid return stream 545 of the first cryogenic fluid which may be returned to the first cryotank 510. The controller 590 is configured to receive information regarding one or more streams or flows through the system 500, and to control the various flows or streams (e.g., by controlling the settings on one or more valves, pumps, or the like) through the system 500.

The first cryotank 510 in the illustrated embodiment is used to contain a first cryogenic fluid (e.g., LNG), and may be configured generally similar to the first cryotank 110 discussed above. The control valve 520 is configured to control a flow of boil-off gas out of the first cryotank 510 in the downstream direction 502 to the boil-off detection module 530 and the heat exchanger 540. In the illustrated embodiment, the control valve 520 is interposed between the first cryotank 510 and the boil-off detection module 530, and is disposed downstream of the cryotank 510 and upstream of the boil-off detection module 530. In some embodiments, the control valve 520 may be mounted inside, mounted to, or otherwise associated with the first cryotank 510. In the illustrated embodiment, when a pressure exceeding a threshold is detected by the tank sensor 512, the control valve 520 opens to allow passage of boil-off gas in the downstream direction 502 as the boil-off gas stream 525, thereby helping reduce the pressure in the first cryotank 510. In various embodiments, the boil-off gas may be passed from the first cryotank 510 at a pressure slightly higher than atmospheric pressure and at the saturation temperature of natural gas (which may be lower than ambient temperature).

As the boil-off gas stream 525 travels downstream from the control valve 520, the boil-off gas stream passes through, by, or otherwise proximate to the boil-off detection unit 530. The boil-off detection unit 530 is configured to sense or detect one or more characteristics or properties of the boil-off gas stream 525. For example, the boil-off detection unit 530 may directly measure a flow (e.g., mass flow or volume flow) of the boil-off gas stream 525. As another example, the boil-off detection unit 530 may measure or detect one or more of a pressure, velocity, or temperature of the boil-off gas stream 525.

The boil-off detection unit 530 is configured to provide information corresponding to the detected one or more properties or characteristics to the controller 590, and the controller 590 is configured to use the information regarding the boil-off gas stream 525 to determine a required flow of a second cryogenic fluid (e.g., LN₂) through the heat exchanger to condense the boil-off gas stream 525. The controller 590 may then direct the desired flow of the second cryogenic fluid through the heat exchanger 540 (e.g., via controlling the settings of one or more valves, pumps, or the like), monitor the heat exchange and condensing of the boil-off gas stream 525 (e.g., via one or more detectors positioned within or otherwise proximate to the heat exchanger 540), and make adjustments to the control of one or more aspects of the system 500 as appropriate to achieve a desired condensing and/or cooling of the boil-off gas stream 525.

In the illustrated embodiment, the flow of the second cryogenic fluid (e.g., LN₂) is provided from the second cryotank 560. The second cryotank 560 may be similar to the second cryotank 160 discussed above in certain respects. In the illustrated embodiment, the second cryotank 560 may be substantially smaller in capacity than the first cryotank 510. In the illustrated embodiment, the second cryotank 560 may be configured to maintain or hold the second cryogenic fluid at a lower temperature than the second cryotank 160. For example, the second cryogenic fluid may be maintained at a temperature substantially lower than the saturation temperature of the second cryogenic fluid so that the second cryogenic fluid may be passed, at least for a time, through the heat exchanger 540 without changing to a gaseous state, and be returned to the second cryotank 560 as a liquid (which may, in some embodiments, not be refrigerated or otherwise cooled so that the liquid returns to the second cryotank 560 at a higher temperature than the temperature of the liquid originally released from the second cryotank 560). In other embodiments, the return stream from the heat exchanger 540 to the second cryotank 560 may be refrigerated or otherwise cooled.

The system 500 also includes a detector 562 and a pressurization module 564 disposed proximate to the second cryotank 562. The detector 562 is depicted schematically as a single block but may include more than one detectors or sensors. The detector 562 is configured to sense or detect one or more properties or characteristics of the liquid stream 575 leaving the second cryotank 560 (e.g., one or more of mass or volumetric flow rate, velocity, temperature, pressure, or the like) and to provide corresponding information to the controller 590. The controller 590 may use the information to determine an appropriate flow rate for the liquid stream 575 and/or to monitor the liquid stream 575.

In the illustrated embodiment, the system 500 includes a pressurization module 564 configured to provide a pressure gradient configured to direct a desired amount of the second cryogenic fluid (e.g., LN₂) in the liquid stream 575 from the second cryogenic tank 560 to the heat exchanger 540. For example, the pressurization module 564 may be a pump operated under the control of the controller 590.

The depicted system 500 also includes a control valve 570 interposed between the second cryogenic tank 560 and the heat exchanger 540. The control valve 570 is configured to control the flow of the liquid stream 575 from the second cryogenic tank 560 to the heat exchanger 540. For example, settings of the control valve 570 may be controlled by the controller 590 to allow a desired amount of flow of the liquid stream 575 through the control valve 570 to the heat exchanger 540. As also discussed above, when the temperature of the liquid stream 575 is raised (e.g., by absorption of heat from the condensing boil-off gas stream 525) without evaporating the liquid stream 575, an increased amount of flow (compared to when the liquid stream 575 is evaporated) of the liquid stream 575 may be required.

The boil-off gas stream 525 (from the first cryotank 510) and the liquid stream 575 (from the second cryotank 560) each advance to and through the heat exchanger 540. The heat exchanger 540 is configured to transfer a sufficient amount of heat from the boil-off gas stream 525 to the liquid stream 575 to condense at least a portion of the boil-off gas stream 525 to provide a return stream 545. In some embodiments, substantially all of the boil-off gas steam 525 may be condensed to provide a return stream 545 that is substantially entirely liquid to the first cryotank 510.

The heat exchanger 540 depicted in FIG. 5 may be configured similarly to the heat exchanger 140 discussed above in certain respects. For example, the heat exchanger 540 includes a first passage 542 having an inlet 544 and an outlet 546, and a second passage 548 having an inlet 550 and an outlet 552. The first and second passages 542, 548 are configured to provide heat exchange between streams passing through the respective passages. In general, the heat exchanger 540 is sized and configured to provide sufficient flow of the liquid stream 575 and the boil-off gas stream 525 as well as sufficient heat exchange therebetween to condense a desired amount of the boil-off gas stream 525.

The boil-off gas stream 525 passes in the downstream direction 502 to the inlet 544 of the first passage 542. As the boil-off gas stream 525 passes through the first passage 542, the boil-off gas stream 525 exchanges heat to the liquid stream 575 (in the second passage 548) in an amount sufficient to condense the boil-off gas stream 525 (e.g., the controller 590 operates the system 500 to provide a sufficient liquid stream 575 to absorb sufficient heat to condense the boil-off gas stream 125). For example, when the liquid stream 575 is not being evaporated or boiled during passage through the heat exchanger 540, a higher flow of the liquid stream 575 may be required. The condensation of the boil-off gas stream produces a return stream 545 of the first cryogenic fluid in a liquid state (e.g., LNG) that is directed to the first cryogenic tank 510 to replenish the first cryogenic tank 510.

As the return stream 545 (e.g., LNG resulting from the condensation of the boil-off gas stream 525) exits the outlet 546 of the heat exchanger 540, the return stream 545 passes through a return stream detector 554. The return stream detector 554 is configured to detect one or more of a flow, temperature, velocity, pressure, or the like of the return stream 545. Information from the return stream detector 554 may be provided to the controller 590, and the controller 590 may adjust or otherwise control operation of the system 500 responsive to the information acquired from the return stream detector 554.

In some embodiments, a pressure gradient provided from the build-up of boil-off gas within the first cryotank 510 may be sufficient to cause the passage of the first cryogenic fluid (e.g., the boil-off gas stream 525 and the return stream 545) from the first cryotank 510 through the heat exchanger 540 and back to the first cryotank 510. In other embodiments, a pressurization module or device (e.g., a pump or fan) configured to provide a pressure gradient through at least a portion of the circuit 506 may be used. In the illustrated embodiment, the system 500 includes a pressurization module 514 disposed proximate the first cryotank 510 and upstream of the heat exchanger 540. In the illustrated embodiment, the pressurization module 514 is configured as a fan for directing the movement of the boil-off gas stream 525, which is in a gaseous state.

Returning to the heat exchanger 540, the liquid stream 575 enters the inlet 550 of the second passage 548. As the liquid stream 575 passes through the second passage 548, heat from the condensing boil-off gas stream 525 is transferred to the liquid stream 575. The transferred heat may raise the temperature of the liquid stream 575 and/or cause a phase transformation or change (e.g., evaporation or boiling from a liquid state to a gaseous state) of the liquid stream 575. In the embodiment depicted in FIG. 1, the liquid stream 575 is initially maintained at a low enough temperature in the second cryotank 560 such that the second cryogenic fluid may be directed through the second circuit 508 one or more times before reaching the saturation temperature, with second cryogenic fluid leaving the heat exchanger in a liquid state being returned to the second cryogenic tank 560. As the second cryogenic fluid is recycled and warmed via passage through the second circuit 508 (via absorption of heat from the boil-off gas stream 525 in the heat exchanger 540), the second cryogenic fluid may reach the saturation temperature of the second cryogenic fluid (e.g., about 77 degrees K for LN₂). Once the liquid stream 575 containing the second cryogenic fluid is near enough the saturation temperature, the liquid stream 575 is evaporated as the liquid stream 575 passes through the second passage 548. Thus, the exhaust stream 577 exiting the outlet 552 of the second passage 548 may be in a liquid and/or gaseous state in various embodiments.

As the exhaust stream 577 exits the heat exchanger, the exhaust stream 577 passes through the exhaust detector 556. The exhaust detector 556 is configured to detect one or more of a flow, temperature, velocity, pressure, or the like of the exhaust stream 577. Information from the exhaust detector 556 may be provided to the controller 590, and the controller 590 may adjust or otherwise control operation of the system 500 responsive to the information acquired from the exhaust detector 556. For example, if the exhaust stream 577 is at a higher temperature than desired, the controller 590 may control the system 500 to provide an increased flow of the liquid stream 575 from the second cryotank 560 to the heat exchanger 540. Further, the controller 590 may determine the state or phase (e.g., liquid or gaseous) of the exhaust stream 577 using information acquired from the exhaust detector 556, and direct the exhaust stream 577 based on the state or phase of the exhaust stream 577.

In the illustrated embodiment, as the exhaust stream 577 proceeds away from the heat exchanger 540, the exhaust stream 577 reaches the splitter valve 580. The splitter valve 580 is configured to direct the exhaust stream along one or more paths. The splitter valve 580 may have one or more settings that are controlled by controller 590. For example, at a first setting, the splitter valve 580 may direct the exhaust stream along a path 581 that is part of the second circuit 508, with the exhaust stream 577 returned to the second cryotank 560 along the path 581. As another example, at a second setting, the splitter valve 580 may direct the exhaust stream along a path 583 from which the exhaust stream may be one or more of directed to the first cryotank 510 (e.g., to purge surroundings of the first cryotank 510 of leakage), to a jet fuel tank (e.g., to inert the jet fuel tank), to an evaporator (e.g., to purge the evaporator of unconsumed natural gas), vented to the atmosphere, or the like.

In some embodiments, the controller 590, using information acquired from the exhaust detection module 556, determines if the exhaust stream 577 is substantially liquid or substantially gaseous. If the exhaust stream 577 is substantially gaseous as determined by the controller 590, the controller 590 controls the splitter valve 580 to direct the gaseous exhaust stream (e.g., nitrogen gas) along path 583 to one or more of the atmosphere, a jet fuel tank, an evaporator, or the like as discussed above. If, however, the exhaust stream 577 is substantially liquid as determined by the controller 590, the controller 590 controls the splitter valve 580 to return the exhaust stream (e.g., LN₂) to the second cryotank along the path 581. In some embodiments, the exhaust stream may be refrigerated or otherwise cooled along the path 581. In other embodiments, the path 581 may be devoid of refrigeration or other cooling of the exhaust stream being returned to the second cryotank 560.

As also indicated above, the controller 590 may be operably connected to and configured to control operations of the various components of the system 500. For example, the controller 590 may acquire information corresponding to the flow of boil-off gas (e.g., one or more of a flow, temperature, or pressure of a boil-off gas stream), determine a flow of a second cryogenic fluid (e.g. LN₂) to absorb a sufficient amount of heat to condense the flow of boil-off gas, and control the various components of the system to provide the required flow to the heat exchanger and operate the system so that the boil-off gas is condensed in the heat exchanger. The controller 590 may be configured as a computer processor or other logic-based device that performs operations based on one or more sets of instructions (e.g., software). The instructions on which the controller 590 operates may be stored on a tangible and non-transitory (e.g., not a transient signal) computer readable storage medium, such as a memory 596. The memory 596 may include one or more computer hard drives, flash drives, RAM, ROM, EEPROM, and the like. Alternatively, one or more of the sets of instructions that direct operations of the controller 590 may be hard-wired into the logic of the controller 590, such as by being hard-wired logic formed in the hardware of the controller 590.

The controller 590 of the illustrated embodiment includes a detection module 592, a control module 594, and a memory module 596 associated therewith. The detection module 592 is configured to receive information from sensors or detectors associated with the system. The detection module 592 may also process the received information to determine one or more operating parameters of the system 500 (e.g., a flow to be provided (e.g., a flow of the liquid stream 575) and/or one or more settings of one or more components of the system 500 (e.g., a pump, a fan, a valve, or the like) to achieve the desired flow). The control module 594 is configured to receive information from the detection module 592 and to control operation of the system 500 responsive to the received information. By way of example, the controller 590 in the illustrated embodiment may, responsive to information received from sensors or detectors, control the amount of flow of the liquid stream 575 from the second cryotank 560, control the settings of the splitter valve 580, control the settings of the control valve 520, or the like. Further, the controller 590 may be configured to control settings of various valves or other components associated with the heat exchanger 540 to direct the various flows through the heat exchanger 540. For example, when the controller 590 determines that a sufficient amount of heat may be absorbed by the second cryogenic fluid without evaporating the second cryogenic fluid, a first flow may be calculated for the second cryogenic fluid based on an energy corresponding only by a rise in temperature of the second cryogenic fluid. When the controller 590 determines that the second cryogenic fluid will be evaporated in the heat exchanger 540 to provide the sufficient amount of heat absorption, a second flow (e.g., lower than the first flow) may be calculated for the second cryogenic fluid based on an energy corresponding to the evaporation or boiling of the second cryogenic fluid. The controller 590 may then adjust the setting of one or more pumps, valves, or the like to achieve the desired flow of the second cryogenic fluid. The controller 590 may also receive information monitoring the output of one or more outlets of the heat exchanger, and adjust operation of the system as appropriate, for example, based on a difference in actual conditions of one or more streams leaving the heat exchanger from predicted conditions (e.g., a deviation in temperature or pressure, a stream exiting the heat exchanger in a different phase or state than expected or desired, or the like).

It should be noted that the embodiments discussed herein (e.g, systems 100, 500) are provided by way of example and not limitation, as various components of the above example embodiments may be combined, added, removed, or re-arranged to form additional embodiments.

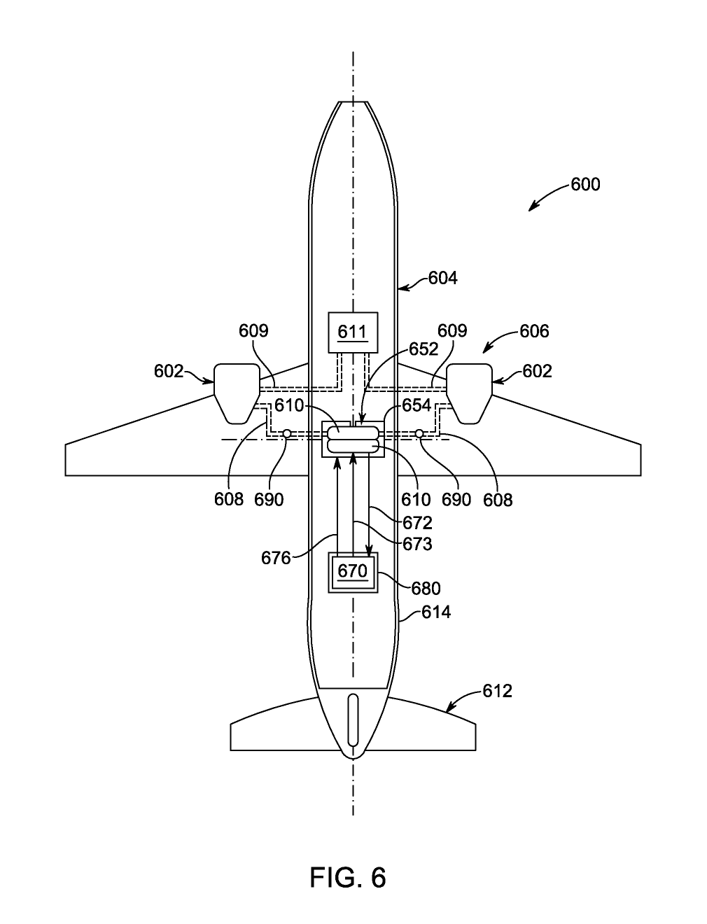

As indicated above, a cryogenic tank may be located on-board an aircraft for containing fuel for an engine of the aircraft. For example, FIG. 6 is a schematic illustration of an exemplary embodiment of an aircraft 600 that includes one or more engines 602 that use a cryogenic fluid as fuel. In the exemplary embodiment of the aircraft 600, the cryogenic fluid used as fuel for the engine 602 and contained by the cryogenic tank 610 on-board the aircraft 600 is LNG. In various embodiments, the cryogenic fluid contained by the cryogenic tank 610 for use as fuel for the aircraft engine 602 may be any type of cryogenic fluid (which may be contained within the cryogenic tank 610 in liquid and/or gaseous form) that is suitable for use as fuel for the aircraft engine 602. The depicted aircraft 600 is configured as a dual fuel aircraft, and is configured so that the engine 602 may use LNG from the cryogenic tank 610 or jet fuel (e.g., JP-8) stored in a jet fuel tank 611. Various fuels may provide different advantages and/or drawbacks. For example, as of the time of submission of this disclosure, JP-8 may provide more available power to the engine 602, while LNG may be more affordable. Thus, JP-8 may be consumed by the engine 602 during events that require more power (e.g., take-off, emergencies, or the like) while LNG may be used during events that require less power (e.g., cruising or the like). In the exemplary embodiment of the aircraft 600, the aircraft 600 is a fixed wing airplane. In the embodiment depicted in FIG. 6, the aircraft 600 is configured as a dual-fuel aircraft. In alternate embodiments, the aircraft 600 may be configured to use only a single fuel, such as LNG or other cryogenic fuel.

The aircraft 600 includes an airframe 604 and an engine system 606, which includes the engine 602 and the cryogenic tank 610. The engine system 606, including the cryogenic tank 610 and the jet fuel tank 611, is located on-board the airframe 604. Specifically, the engine 602, the cryogenic tank 610, the jet fuel tank 611, and various other components of the engine system 606 are positioned at various locations on and/or within the airframe 604 such that the engine 602, the cryogenic tank 610, the jet fuel tank 611, and the various other components of the engine system 606 are carried by the airframe 604 during flight of the aircraft 600. It may be noted that the various components of the engine system (e.g., the engine 602 and the cryogenic tank 610) need not necessarily be mounted together. Components of the engine system 606, such as the cryogenic tank 610, may be configured for removal and replacement from the aircraft 600.

The engines 602 of the illustrated embodiment are operatively connected in fluid communication to receive cryogenic fluid from the cryogenic tank 610, for example through fuel conduits 608. The engines 602 use the cryogenic fluid as fuel to generate thrust for generating and controlling flight of the aircraft 600. The cryogenic fluid may be stored as a liquid in the cryogenic tank 610, but may be provided to the engines 602 in a gaseous state. The engine system 606 may include one or more fuel pumps (not shown). Each fuel pump is operatively connected in fluid communication with the cryogenic tank 610 and with one or more corresponding engines 602 for pumping cryogenic fluid from the cryogenic tank 610 to the engine(s) 602. Fuel pumps may be disposed in various locations along the airframe 604, such as, but not limited to, within an internal volume of the cryogenic tank 610, mounted to a corresponding engine 602, located proximate a corresponding engine 602, or the like. Similarly, the engines 602 are operatively connected in fluid communication to receive jet fuel (e.g., JP-8) from the jet fuel tank 611, for example, through fuel conduits 609. The engine system 606 may also include one or more fuel pumps (not shown) associated with the jet fuel tank 611.

In the exemplary embodiment of the aircraft 600 depicted in FIG. 6, the engines 602 are configured to use two different fuels, including at least natural gas as fuel. In some other embodiments, the engines 602 are configured to use at least another cryogenic fluid as fuel. For example, the engines 602 may be configured to utilize hydrogen (H₂) as a fuel. In various embodiments, the cryogenic fluid pumped from the cryogenic tank 610 to the engines 602 may be supplied to the engines 602 in a gaseous form and/or as a liquid, no matter in which state(s) the cryogenic fluid is contained in the cryogenic tank 610. For example, in the exemplary embodiment of the aircraft 600, the engines 602 use the natural gas as fuel in the gaseous state. The engine system 606 may include one or more heating systems that heat LNG stored by the cryogenic tank 610 to change the LNG stored by the cryogenic tank 610 to the gaseous state for supply to the engines 602 as fuel. In the illustrated embodiment, the engine system 606 may also include one or more evaporators 690 disposed along a fuel conduit 608 and interposed between the cryogenic tank 610 and an engine 602, with the evaporators 690 configured to change LNG provided by the cryogenic tank 610 to natural gas in a gaseous state or phase to be supplied to the engines 602. In various embodiments, the evaporator(s) may be integrated with the engine(s).

Each engine 602 may be any type of engine, such as, but not limited to, a turbine engine, an engine that drives a propeller or other rotor, a radial engine, a piston engine, a turboprop engine, a turbofan engine, and/or the like. Although two engines are shown in the illustrated embodiments, the aircraft 600 may include any number of engines 602. Although shown located on wings 610 of the airframe 604 in FIG. 6, in various embodiments different mounting locations for each engine 602 along the airframe 604 may be employed. For example, the aircraft 600 may include an engine located at a tail 612 and/or another location along a fuselage 614 of the airframe 604.

The cryogenic tank 610 is supported on one or more support surfaces 652 of the aircraft 600. In the exemplary embodiment of the aircraft 600, the cryogenic tank 610 is supported on two pallets 654 that are loaded on-board the aircraft 600 and include the support surface 652. In other embodiments, the cryogenic tank 610 may be supported on a single pallet. The cryogenic tank 610 may be secured to the pallets 654 using any suitable attachment member, such as, but not limited to, straps, cables, chains, clamps, threaded fasteners, and/or the like. In some embodiments, the attachment member(s) used to secure the cryogenic tank 610 to the pallets 654 is selected such that the cryogenic tank 610 is configured to withstand up to or greater than an acceleration of approximately nine times gravitational acceleration without dislodging from the pallets 654. In some embodiments, the cryogenic tank 610 is connected directly to the fuselage 614 via support feet or the like.

A boil-off gas re-condensation system 670 is also mounted to the aircraft 600 and operatively connected to the cryogenic tank 600. For example, the boil-off gas re-condensation system 670 may be connected to the cryogenic tank 610 via a boil-off gas conduit 672. The boil-off gas conduit 672, for example, may include a length of piping and/or hose along with appropriate connection members. A control valve for controlling the flow of boil-off gas from the cryogenic tank 610 to the boil-off gas re-condensation system 670 may be positioned along the boil-off gas conduit 672 or otherwise associated therewith. The boil-off gas re-condensation system 670 may be generally configured similarly to the systems 100, 500 discussed above. For example, the boil-off gas re-condensation system may include one or more valves, pressurization modules, detectors, heat exchangers, control units, a cryotank for supply of a cryogenic fluid for absorption of heat from condensation of a boil-off gas, or the like as discussed above in connection with the embodiments depicted in FIGS. 1 and 5.

In the illustrated embodiment, the boil-off gas re-condensation system 670 is mounted on a pallet 680 that is removably mounted to the aircraft 600. Thus, the boil-off gas re-condensation system may be readily loaded on or un-loaded off of the aircraft 600. The pallet 680 may be configured and mounted in a generally similar fashion as discussed above in connection with the pallets 654. In various embodiments, the boil-off gas re-condensation system 670 may be mounted on the same pallet or pallets as the cryogenic tank 610 and configured to be loaded or un-loaded therewith as a single effective unit. In some embodiments, the boil-off gas re-condensation system 670 may be a separately loadable unit mounted on one or more dedicated pallets (e.g., pallet 680) and operatively connected to the cryogenic tank 610 after loading. In some embodiments, the boil-off gas re-condensation system 670 may include a dedicated controller, while in other embodiments, a control module associated with additional operations of the aircraft 600 may be employed to control the operation of the boil-off gas re-condensation system 670. In some embodiments, one or more of the cryogenic tank 610, the boil-off gas re-condensation system 670, and/or various aspects thereof may be removably mounted (e.g., via pallets), while in some embodiments one or more of the cryogenic tank 610, the boil-off gas re-condensation system 670, and/or various aspects thereof may be permanently mounted.

In the illustrated embodiment, the boil-off gas re-condensation system 670 is configured to receive boil-off gas from the cryogenic tank 610 via the boil-off gas conduit 672, condense at least a portion of the received boil-off gas, and provide a return stream to the cryogenic tank 610 via a return conduit 673. In some embodiments, the return stream may be substantially in an entirely liquid state. The boil-off gas re-condensation system 670 may also produce a gaseous exhaust (e.g., gaseous nitrogen) resulting from evaporation of a second cryogenic fluid (e.g., LN₂) that absorbs heat from the condensation of the boil-off gas. The gaseous exhaust may be directed along a conduit 676 to a volume proximate or surrounding the cryogenic tank 610 (e.g., to purge leakage from the cryogenic tank 610 or associated components), along a conduit (not shown) to an evaporator (e.g., to purge one or more evaporators 690), along a conduit (not shown) to a fuel tank (e.g., to inert one or more jet fuel tanks 611), or the like.

The cryogenic tank 610 and/or the boil-off gas re-condensation system 670 may be located at any suitable location on and/or within the airframe 604. In the exemplary embodiment of the aircraft 600, the pallets 654 and the cryogenic tank 610 supported thereon as well as the pallet 680 and the boil-off gas re-condensation system 670 supported thereon are located within a cargo hold of the fuselage 614 of the airframe 604. In the illustrated embodiment, the cryogenic tank 610 and the boil-off gas re-condensation system 670 are not integral to the airframe 604 of the aircraft 600. Instead, the cryogenic tank 610 and the boil-off gas re-condensation system 670 are supported on the pallets configured to be loaded on-board the airframe 604, rather than being integral to the airframe 604. In alternate embodiments, the cryogenic tank 610 and/or one or more aspects of the boil-off gas re-condensation system 670 may be permanently mounted or integral to the airframe 604.

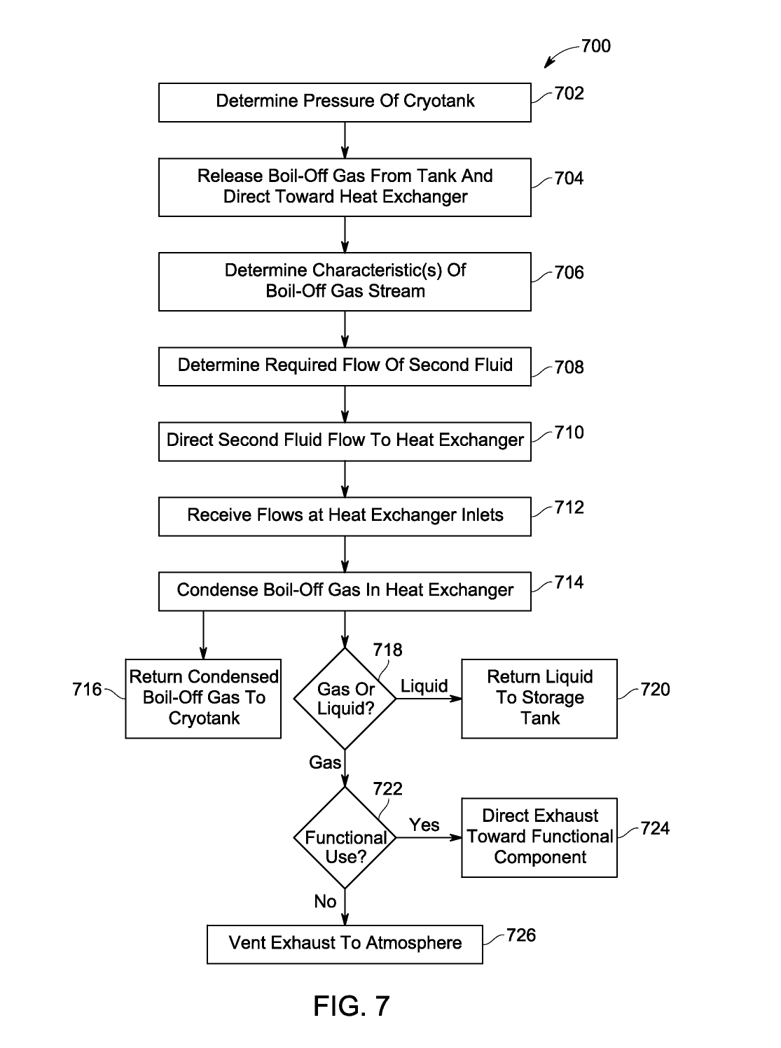

FIG. 7 is a flow chart of a method 700 for re-condensing boil-off gas in accordance with an embodiment. The method 700, for example, may employ structures or aspects of various embodiments discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion.

At 702, a pressure of a cryotank (e.g., a tank configured to contain LNG for use on-board an aircraft) is determined. For example, the pressure within the cryotank may be elevated above a design pressure due to evaporation of the LNG as a boil-off gas. The pressure may be determined, for example, via a detector or sensor positioned proximate to the cryotank.

At 704, if the pressure of the cryotank exceeds a threshold pressure (e.g., about 1.5 atmospheres), boil-off gas from the cryotank may be released through a conduit (e.g., piping) in a downstream direction and directed toward a condensing heat exchanger. For example, a controller receiving information regarding the pressure from the detector or sensor may operate a control valve to release the boil-off gas from the cryotank. The boil-off gas is directed via the conduit for further processing (e.g., re-condensation), allowing the boil-off gas to be returned to the cryotank and reducing the risk of combustibility or otherwise harmful or undesirable consequences of venting the boil-off gas to the atmosphere.

At 706, one or more properties or characteristics of the boil-off gas stream are detected. For example, one or more of a flow (e.g., mass flow rate or volumetric flow rate), temperature, velocity, pressure, or the like may be sensed or detected by one or more detection units disposed along a circuit or path along which the boil-off gas stream travels.

At 708, a required flow of a second fluid is determined. In various embodiments, the required flow determined is the flow required for the second fluid to absorb sufficient heat in a heat exchanger from the boil-off gas to condense at least a portion of the boil-off gas. In some embodiments, the flow may be determined to provide sufficient energy absorption to condense substantially all of the boil-off gas in the boil-off gas stream. Further, the flow may be determined to lower the temperature of a condensed stream exiting a heat exchanger a given amount below the saturation temperature or boiling point. For example, using the mass or mass flow rate of the boil-off gas (e.g., determined from a boil-off gas flow rate over a given amount of time), a total energy to be removed from the boil-off gas stream over a given amount of time may be determined. Various characteristics of the boil-off gas (e.g., temperature, pressure, specific heat capacity, latent heat of evaporation, or the like) may be used to determine the energy required. Next, the amount of a second fluid (e.g., LN₂) to absorb the desired amount of energy may be determined. The amount of energy required may be adjusted, for example, to account for inefficiency in a system or to provide a safety factor. The amount of second fluid required may be affected by a number of factor, such as the temperature of the second fluid in a tank from which the second fluid is supplied, the pressure at which the second fluid will be supplied, whether the second fluid will be evaporated or not during passage through the heat exchanger, the specific heat capacity of the second fluid, the latent heat of evaporation of the second fluid, or the like. The determination of the required flow of the second fluid may be made, for example, by a control unit responsive to information acquired from one or more detectors or sensors that detect or sense one or more characteristics of one or more flows or streams passing through a boil-off gas re-condensation system.

At 710, a flow of the second fluid from a second tank corresponding to the flow determined at 708 is directed toward the heat exchanger. The second fluid may be a cryogenic fluid in a liquid state (e.g., LN₂) supplied by a tank. The flow of the second fluid may be directed to an inlet of a second passage of the heat exchanger while the flow of the boil-off gas (see step 704) may be directed to an inlet of a first passage of the heat exchanger. The first and second passages of the heat exchanger are configured to provide for the exchange of heat between fluids traversing the first and second passages. For example, the first and second passages may be configured as coils that overlap or otherwise positioned proximate to each other.

At 712, the boil-off gas is received at the inlet of the first passage of the heat exchanger and the second fluid is received at the inlet of the second passage of the heat exchanger. At 714, at least a portion of the boil-off gas is condensed as the boil-off gas stream and the second fluid pass through the heat exchanger. In some embodiments, substantially all of the boil-off gas may be condensed, providing a condensed stream that is substantially entirely liquid that may be returned to the cryotank from which the boil-off gas was originally released. To condense the boil-off gas, heat from the boil-off gas stream is transferred to the stream of the second fluid. For example, the second fluid may have a saturation temperature lower than the boil-off gas, with the second fluid maintained at or below the saturation temperature in a second cryotank. As the heat from the condensing boil-off gas is absorbed by the second fluid, the second fluid may experience a rise in temperature and/or a change from a liquid state to a gaseous state (e.g., if the second fluid enters the heat exchanger at the saturation temperature of the second fluid, or if the saturation temperature of the second fluid is reached as the second fluid is heated in the heat exchanger).

At 716, the condensed boil-off gas (e.g., LNG) is returned to the cryotank from which the boil-off gas stream originally emanated. The return stream may be in a substantially entirely liquid state, and may, in some embodiments, be cooled below the saturation temperature of the boil-off gas.

At 718, it is determined if the exhaust stream resulting from the passage of the second fluid (e.g., LN₂), which was used to absorb heat from the condensing boil-off gas is substantially liquid or substantially gaseous.

If the exhaust stream is determined to be substantially liquid, the exhaust stream is returned to the tank storing the second fluid at 720. In some embodiments, the second fluid may be initially maintained at a temperature below the saturation temperature and be re-cycled from the heat exchanger to the second tank until the second fluid reaches the saturation temperature is evaporated in the heat exchanger. In some embodiments, the second fluid may be maintained at or about the saturation temperature, and be evaporated upon an initial passage through the heat exchanger. In still other embodiments, the second fluid may be cooled by refrigeration or otherwise during a return from the heat exchanger, while in other embodiments the return path or circuit from the heat exchanger to the tank holding the second fluid may be devoid of a refrigeration or other cooling device or system.

If the exhaust stream is determined to be substantially gaseous in state, the method proceeds to 722. At 722, it is determined if a functional component has use for the gaseous exhaust stream (e.g., nitrogen gas in embodiments using LN_{Z} as the fluid for absorbing heat from the condensation of the boil-off gas). For example, a boil-off gas re-condensation system may be disposed on-board a vehicle, such as an aircraft. Various functional components of an aircraft may have use for a stream of the exhaust gas (e.g., nitrogen gas). For example, various functional components of an aircraft, such as a jet fuel tank, an evaporator disposed along a fuel conduit, or the like may be purged or inerted using the exhaust stream.

At 724, if it is determined that a functional component has use for the exhaust stream, the exhaust stream is directed to one or more functional components. For example, a gaseous nitrogen stream may be used to purge or inert an evaporator, a jet fuel tank, electrical wires that may be exposed to natural gas or other combustible fluid, or the like.

At 726, if it is determined that a functional component does not have use for the exhaust stream, the exhaust stream (e.g., nitrogen gas) may be vented to the atmosphere.

Thus, various embodiments provide for reduced emission of combustible gases and/or otherwise potentially harmful emissions, while providing for relatively compact, lightweight cryogenic tanks and re-condensing systems that are configured to condense and return a boil-off gas stream of a cryogenic fluid to a cryotank. Various embodiments may alternatively or additionally provide an exhaust gas stream (e.g., a nitrogen stream) that may be used to purge or inert a functional component (e.g., an evaporator, a fuel tank, or the like) of an aircraft system. Various embodiments may also provide improved conservation of a fuel (e.g., LNG).

Various embodiments of systems and methods are described and illustrated herein with respect to being used in conjunction with a fuel tank on-board an aircraft for containing LNG that is used as fuel for an engine of the aircraft. However, certain embodiments are not limited to being used with aircraft, and are not limited to containing LNG. For example, various embodiments of may be located on any other stationary and/or mobile platform, such as, but not limited to, trains, automobiles, watercraft (e.g., a ship, a boat, a maritime vessel, and/or the like), or the like.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid state drive, optical drive, and the like. The storage device may also be other similar means for loading computer programs or other instructions into the computer or processor.

As used herein, the term “computer”, “controller”, and “module” may each include any processor-based or microprocessor-based system including systems using microcontrollers, reduced instruction set computers (RISC), application specific integrated circuits (ASICs), logic circuits, GPUs, FPGAs, and any other circuit or processor capable of executing the functions described herein. The above examples are exemplary only, and are thus not intended to limit in any way the definition and/or meaning of the term “module” or “computer.”

The computer, module, or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer, module, or processor as a processing machine to perform specific operations such as the methods and processes of the various embodiments described and/or illustrated herein. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program. The individual components of the various embodiments may be virtualized and hosted by a cloud type computational environment, for example to allow for dynamic allocation of computational power, without requiring the user concerning the location, configuration, and/or specific hardware of the computer system.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, and also to enable a person having ordinary skill in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal languages of the claims.

What is claimed is:

1. A system, comprising:
a heat exchanger having a first passage and a second passage configured for exchange of heat therebetween, the first passage configured to receive at an inlet a boil-off gas stream of a first cryogenic fluid from a first tank, the second passage configured to receive at an inlet a liquid stream of a second cryogenic fluid from a second tank, wherein the second cryogenic fluid has a lower evaporation temperature than the first cryogenic fluid;
a detection unit configured to detect a characteristic of the boil-off gas stream; and
a controller configured to acquire information from the detection unit corresponding to the characteristic and, responsive to the information acquired from the detection unit, to control the flow of the second cryogenic fluid from the second tank to provide sufficient exchange of heat from the boil-off gas stream via the heat exchanger to condense at least a portion of the boil-off gas stream, whereby a liquid stream of the first cryogenic fluid is output from the first passage and returned to the first tank.

2. The system of claim 1, wherein the controller is configured to control the flow of the second cryogenic fluid such that at least a portion of the second cryogenic fluid evaporates and is discharged as an exhaust gas stream from the second passage of the heat exchanger.

3. The system of claim 2, wherein the controller is configured to direct the exhaust gas stream proximate to a functional component of an aircraft system, wherein the exhaust gas stream is used to at least one of inert or purge one or more aspects of the functional component.

4. The system of claim 1, wherein the detection unit is configured to directly measure a flow of the boil-off gas stream proximate to the inlet of the first passage of the heat exchanger.

5. The system of claim 1, wherein the detection unit is configured to measure at least one of a pressure, velocity, or temperature of the boil-off gas stream.

6. The system of claim 1, wherein the controller is configured to control the flow of the second cryogenic fluid such that at least a portion of the second cryogenic fluid remains in a liquid state throughout the second passage of the heat exchanger and is returned as an output liquid stream to the second tank.

7. The system of claim 6, wherein the output liquid stream is returned to the second tank without being cooled.

8. The system of claim 1, further comprising a pressurization module configured to provide a pressure gradient used to direct a flow of at least one of the boil-off gas or the liquid stream of the first cryogenic fluid.

9. A method for re-condensing a boil-off gas stream of a first cryogenic fluid from a first tank comprising:
receiving the boil-off gas stream at an inlet of a first passage of a heat exchanger;
determining, using information corresponding to a characteristic of the boil-off gas stream, a flow of a stream of a second cryogenic fluid from a second tank through a second passage of the heat exchanger to condense at least a portion of the boil-off gas stream as the boil-off gas stream passes through the first passage;
receiving the stream of the second cryogenic fluid at an inlet of the second passage of the heat exchanger;
condensing at least a portion of the boil-off gas stream to provide a liquid stream of the first cryogenic fluid from an outlet of the first passage of the heat exchanger; and
returning the liquid stream of the first cryogenic fluid to the first tank.

10. The method of claim 9, further comprising evaporating at least a portion of the stream of the second cryogenic fluid as the stream of the second cryogenic fluid passes through the second passage of the heat exchanger to provide an exhaust stream of gas from the second passage of the heat exchanger.

11. The method of claim 10, further comprising directing the exhaust stream proximate to a functional component of an aircraft system and using the exhaust stream to at least one of purge or inert one or more aspects of the functional component.

12. The method of claim 9, wherein at least a portion of the stream of the second cryogenic fluid remains in a liquid state to provide a return stream of the second cryogenic fluid, further comprising directing the return stream to the second tank without cooling the return stream.

13. The method of claim 9, wherein the information corresponding to the characteristic of the boil-off gas stream includes flow information acquired via a direct measurement of flow.

14. The method of claim 9, wherein the information corresponding to the characteristic of the boil-off gas stream includes a measurement of at least one of a pressure, velocity, or temperature of the boil-off gas stream.

15. The method of claim 9, further comprising determining if an exit stream from the second passage of the heat exchanger is in a substantially liquid or a substantially gaseous state, and returning the exit stream to the second tank if the exit stream is in a substantially liquid state.

16. A tangible and non-transitory computer readable medium comprising one or more computer software modules configured to direct at least one processor to:
determine, using information corresponding to a characteristic of a boil-off gas stream of a first cryogenic fluid from a first tank configured to enter a first passage of a heat exchanger, a flow of a stream of a second cryogenic fluid from a second tank through a second passage of the heat exchanger to condense at least a portion of the boil-off gas stream as the boil-off gas stream passes through the first passage;
direct the stream of the second cryogenic fluid into an inlet of the second passage of the heat exchanger;
whereby at least a portion of the boil-off gas stream is condensed to provide a liquid stream of the first cryogenic fluid from an outlet of the first passage of the heat exchanger as the boil-off gas stream passes through the first passage; and
direct the liquid stream of the first cryogenic fluid to the first tank.

17. The tangible and non-transitory computer readable medium of claim 16, wherein the one or more software modules are further configured to direct the at least one processor to evaporate at least a portion of the stream of the second cryogenic fluid as the stream of the second cryogenic fluid passes through the second passage of the heat exchanger to provide an exhaust stream of gas from the second passage of the heat exchanger.

18. The tangible and non-transitory computer readable medium of claim 17, wherein the one or more software modules are further configured to direct the at least one processor to direct the exhaust stream proximate to a functional component of an aircraft system and using the exhaust stream to at least one of purge or inert one or more aspects of the functional component.

19. The tangible and non-transitory computer readable medium of claim 16, wherein at least a portion of the stream of the second cryogenic fluid remains in a liquid state to provide a return stream of the second cryogenic fluid, wherein the one or more software modules are further configured to direct the at least one processor to direct the return stream to the second tank without cooling the return stream.

20. The tangible and non-transitory computer readable medium of claim 16, wherein the information corresponding to the characteristic of the boil-off gas stream includes flow information acquired via a direct measurement of flow.
